(19) United States
(12) Patent Application Publication
(10) Pub. No.: US 2025/0220672 A1
(43) Pub. Date: Jul. 3, 2025

(54) METHODS AND APPARATUSES FOR UPLINK TRANSMISSION IN A FULL DUPLEX SYSTEM

(71) Applicant: LENOVO (BEIJING) LIMITED, Beijing (CN)

(72) Inventors: Yuantao ZHANG, Beijing (CN); Ruixiang MA, Beijing (CN); Hongmei LIU, Beijing (CN); Zhi YAN, Beijing (CN); Haiming WANG, Beijing (CN)

(21) Appl. No.: 18/867,254

(22) PCT Filed: May 20, 2022
(86) PCT No.: PCT/CN2022/094178

§ 371 Date: Nov. 19, 2024

(51) Int. Cl. H04W 72/21; H04L 5/00; H04W 72/0453

(52) U.S. Cl. CPC H04W 72/21; H04L 5/001; H04W 72/0453

(57) ABSTRACT

Embodiments of the present disclosure relate to methods and apparatuses for uplink (UL) transmission in a full duplex (FD) system. According to some embodiments of the disclosure, a user equipment (UE) may include: a transceiver configured to receive a configuration indicating one or more set of resources for a bandwidth part (BWP) of the UE; and a processor coupled to the transceiver and configured to determine at least one set of available resources for a subband based on the one or more set of resources for the BWP.

### TECHNICAL FIELD

Embodiments of the present disclosure generally relate to wireless communication technology, and more particularly to methods and apparatuses for uplink (UL) transmission in a full duplex (FD) system.

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time. Details regarding UL transmission in a full duplex system need to be studied.

### SUMMARY

Some embodiments of the present disclosure provide a user equipment (UE). The UE may include: a transceiver configured to receive a configuration indicating one or more sets of resources for a bandwidth part (BWP) of the UE; and a processor coupled to the transceiver and configured to determine at least one set of available resources for a subband based on the one or more sets of resources for the BWP.

In some embodiments of the present disclosure, the subband is associated with the BWP. In some embodiments, a configuration for the subband is within a configuration for the BWP. In some embodiments, the subband is separately configured and is within a region of the BWP. In some embodiments, the receiver is further configured to receive a configuration indicating that the subband is associated with the BWP.

In some embodiments of the present disclosure, the one or more sets of resources are one or more physical uplink control channel (PUCCH) resource sets for the BWP, each PUCCH resource set is configured with one or more PUCCH resources for the BWP; wherein determining the at least one set of available resources for the subband comprises determining, based on the one or more PUCCH resource sets for the BWP, at least one available PUCCH resource set for the subband; and wherein the processor is further configured to determine at least one available PUCCH resource for the subband in the at least one available PUCCH resource set for the subband.

In some embodiments of the present disclosure, to determine at least one available PUCCH resource set for the subband, the processor is configured to: determine a PUCCH resource set for the BWP to be an available PUCCH resource set for the subband in the case that at least one PUCCH resource in the PUCCH resource set is available for the subband.

In some embodiments of the present disclosure, the processor is further configured to: in the case that frequency hopping is not configured for the UE, determine a PUCCH resource in a PUCCH resource set for the BWP to be an available PUCCH resource for the subband when a physical resource(s) of the PUCCH resource is within the subband.

In some embodiments of the present disclosure, the processor is further configured to: determine a PUCCH resource in a PUCCH resource set for the BWP to be an available PUCCH resource for the subband in the case that: only a first physical resource(s) for a first hop of the PUCCH resource is within the subband, only a second physical resource(s) for a second hop of the PUCCH resource is within the subband, or both the first physical resource(s) for the first hop of the PUCCH resource and the second physical resource(s) for the second hop of the PUCCH resource are within the subband.

In some embodiments of the present disclosure, to determine at least one available PUCCH resource set for the subband, the processor is further configured to: determine a PUCCH resource set for the BWP to be an available PUCCH resource set for the subband in the case that a resource identity (ID) of a PUCCH resource in the PUCCH resource set for the BWP is the same as a resource ID of another PUCCH resource configured for the subband.

In some embodiments of the present disclosure, the processor is further configured to override the PUCCH resource configured for the BWP with the another PUCCH resource configured for the subband for a PUCCH transmission in the subband.

In some embodiments of the present disclosure, the transceiver is further configured to transmit a PUCCH in the physical resource(s) in the subband in one or more time units.

In some embodiments of the present disclosure, the transceiver is further configured to: in the case that only the first physical resource(s) is within the subband, transmit a PUCCH in the first physical resource(s) in the subband in one or more time units without frequency hopping regardless of whether frequency hopping is configured for the UE; in the case that only the second physical resource(s) is within the subband, transmit a PUCCH in the second physical resource(s) in the subband in one or more time units without frequency hopping regardless of whether frequency hopping is configured for the UE; or in the case that both the first physical resource(s) and the second physical resource(s) are within the subband, transmit a PUCCH in the first physical resource(s) and the second physical resource(s) in the subband in one or more time units by frequency hopping when the frequency hopping is configured for the UE.

In some embodiments of the present disclosure, the transceiver is further configured to: in the case that the another PUCCH resource comprises only a first physical resource(s) for a first hop, transmit a PUCCH in the first physical resource(s) in the subband in one or more time units without frequency hopping regardless of whether frequency hopping is configured for the UE; in the case that the another PUCCH resource comprises only a second physical resource(s) for a second hop, transmit a PUCCH in the second physical resource(s) in the subband in one or more time units without frequency hopping regardless of whether frequency hopping is configured for the UE; or in the case that the another PUCCH resource comprises both the first physical resource(s) for the first hop and the second physical resource(s) for the second hop, transmit a PUCCH in the first physical resource(s) and second physical resource(s) in the subband in one or more time units by frequency hopping when the frequency hopping is configured for the UE.

In some embodiments of the present disclosure, the configuration is for physical uplink shared channel (PUSCH) resource allocation and is downlink control information (DCI) indicating a set of physical resource blocks (PRBs) for a PUSCH.

In some embodiments of the present disclosure, the transceiver is further configured to receive another configuration indicating a PRB offset value for the PUSCH; and the processor is further configured to: in the case that frequency hopping is configured for the UE, determine a first physical resource(s) for a first hop and a second physical resource(s) for a second hop of the PUSCH based on a start PRB of the set of PRBs and the PRB offset value.

In some embodiments of the present disclosure, determining the at least one set of available resources for the subband comprises determining the set of PRBs to be a set of available PUSCH resources for the subband in the case that the set of PRBs is within the subband.

In some embodiments of the present disclosure, determining the at least one set of available resources for the subband comprises: determining the first physical resource(s) to be a set of available PUSCH resources for the subband in the case that only the first physical resource(s) is within the subband, determining the second physical resource(s) to be a set of available PUSCH resources for the subband in the case that only the second physical resource(s) is within the subband, or determining the first physical resource(s) and the second physical resource(s) to be two sets of available PUSCH resources for the subband in the case that both the first physical resource(s) and the second physical resource(s) are within the subband.

In some embodiments of the present disclosure, the transceiver is further configured to transmit a PUSCH in the set of PRBs in the subband in one or more time units.

In some embodiments of the present disclosure, the transceiver is further configured to: in the case that only the first physical resource(s) is within the subband, transmit a PUSCH in the first physical resource(s) in the subband in one or more time units without frequency hopping regardless of whether frequency hopping is configured for the UE; in the case that only the second physical resource(s) is within the subband, transmit a PUSCH in the second physical resource(s) in the subband in one or more time units without frequency hopping regardless of whether frequency hopping is configured for the UE; or in the case that both the first physical resource(s) and the second physical resource(s) are within the subband, transmit a PUSCH in the first physical resource(s) and the second physical resource(s) in the subband in one or more time units by frequency hopping when the frequency hopping is configured for the UE.

Some embodiments of the present disclosure provide a base station (BS). The BS may include: a transceiver configured to transmit, to a user equipment (UE), a configuration indicating one or more sets of resources for a BWP of the UE; and a processor coupled to the transceiver and configured to determine at least one set of available resources for a subband based on the one or more sets of resources for the BWP.

In some embodiments of the present disclosure, the subband is associated with the BWP. In some embodiments, a configuration for the subband is within a configuration for the BWP. In some embodiments, the subband is separately configured and is within a region of the BWP. In some embodiments, the receiver is further configured to transmit a configuration indicating that the subband is associated with the BWP.

In some embodiments of the present disclosure, the one or more sets of resources are one or more PUCCH resource sets for the BWP, each PUCCH resource set is configured with one or more PUCCH resources for the BWP; wherein determining the at least one set of available resources for the subband comprises determining, based on the one or more PUCCH resource sets for the BWP, at least one available PUCCH resource set for the subband; and wherein the processor is further configured to determine at least one available PUCCH resource for the subband in the at least one available PUCCH resource set for the subband.

In some embodiments of the present disclosure, to determine at least one available PUCCH resource set for the subband, the processor is configured to: determine a PUCCH resource set for the BWP to be an available PUCCH resource set for the subband in the case that at least one PUCCH resource in the PUCCH resource set is available for the subband.

In some embodiments of the present disclosure, the processor is further configured to: in the case that frequency hopping is not configured for the UE, determine a PUCCH resource in a PUCCH resource set for the BWP to be an available PUCCH resource for the subband when a physical resource(s) of the PUCCH resource is within the subband.

In some embodiments of the present disclosure, the processor is further configured to: determine a PUCCH resource in a PUCCH resource set for the BWP to be an available PUCCH resource for the subband in the case that: only a first physical resource(s) for a first hop of the PUCCH resource is within the subband, only a second physical resource(s) for a second hop of the PUCCH resource is within the subband, or both the first physical resource(s) for the first hop of the PUCCH resource and the second physical resource(s) for the second hop of the PUCCH resource are within the subband.

In some embodiments of the present disclosure, to determine at least one available PUCCH resource set for the subband, the processor is further configured to: determine a PUCCH resource set for the BWP to be an available PUCCH resource set for the subband in the case that a resource ID of a PUCCH resource in the PUCCH resource set for the BWP is the same as a resource ID of another PUCCH resource configured for the subband.

In some embodiments of the present disclosure, the processor is further configured to override the PUCCH resource configured for the BWP with the another PUCCH resource configured for the subband for a PUCCH transmission in the subband.

In some embodiments of the present disclosure, the transceiver is further configured to receive a PUCCH in the physical resource(s) in the subband in one or more time units.

In some embodiments of the present disclosure, the transceiver is further configured to: in the case that only the first physical resource(s) is within the subband, receive a PUCCH in the first physical resource(s) in the subband in one or more time units without frequency hopping regardless of whether frequency hopping is configured for the UE; in the case that only the second physical resource(s) is within the subband, receive a PUCCH in the second physical resource(s) in the subband in one or more time units without frequency hopping regardless of whether frequency hopping is configured for the UE; or in the case that both the first physical resource(s) and the second physical resource(s) are within the subband, receive a PUCCH in the first physical resource(s) and the second physical resource(s) in the subband in one or more time units by frequency hopping when the frequency hopping is configured for the UE

In some embodiments of the present disclosure, the transceiver is further configured to: in the case that the another PUCCH resource comprises only a first physical resource(s) for a first hop, receive a PUCCH in the first physical resource(s) in the subband in one or more time units without frequency hopping regardless of whether frequency hopping is configured for the UE; in the case that the another PUCCH resource comprises only a second physical resource(s) for a second hop, receive a PUCCH in the second physical resource(s) in the subband in one or more time units without frequency hopping regardless of whether frequency hopping is configured for the UE; or in the case that the another PUCCH resource comprises both the first physical resource(s) for the first hop and the second physical resource(s) for the second hop, receive a PUCCH in the first physical resource(s) and second physical resource(s) in the subband in one or more time units by frequency hopping when the frequency hopping is configured for the UE.

In some embodiments of the present disclosure, the configuration is for PUSCH resource allocation and is DCI indicating a set of PRBs for a PUSCH.

In some embodiments of the present disclosure, the transceiver is further configured to transmit another configuration indicating a PRB offset value for the PUSCH; and the processor is further configured to: in the case that frequency hopping is configured for the UE, determine a first physical resource(s) for a first hop and a second physical resource(s) for a second hop of the PUSCH based on a start PRB of the set of PRBs and the PRB offset value.

In some embodiments of the present disclosure, determining the at least one set of available resources for the subband comprises determining the set of PRBs to be a set of available PUSCH resources for the subband in the case that the set of PRBs is within the subband.

In some embodiments of the present disclosure, determining the at least one set of available resources for the subband comprises: determining the first physical resource(s) to be a set of available PUSCH resources for the subband in the case that only the first physical resource(s) is within the subband, determining the second physical resource(s) to be a set of available PUSCH resources for the subband in the case that only the second physical resource(s) is within the subband, or determining the first physical resource(s) and the second physical resource(s) to be two sets of available PUSCH resources for the subband in the case that both the first physical resource(s) and the second physical resource(s) are within the subband.

In some embodiments of the present disclosure, the transceiver is further configured to receive a PUSCH in the set of PRBs in the subband in one or more time units.

In some embodiments of the present disclosure, the transceiver is further configured to: in the case that only the first physical resource(s) is within the subband, receive a PUSCH in the first physical resource(s) in the subband in one or more time units without frequency hopping regardless of whether frequency hopping is configured for the UE; in the case that only the second physical resource(s) is within the subband, receive a PUSCH in the second physical resource(s) in the subband in one or more time units without frequency hopping regardless of whether frequency hopping is configured for the UE; or in the case that both the first physical resource(s) and the second physical resource(s) are within the subband, receive a PUSCH in the first physical resource(s) and the second physical resource(s) in the subband in one or more time units by frequency hopping when the frequency hopping is configured for the UE.

Some embodiments of the present disclosure provide a method performed by a UE. The method may include: receiving a configuration indicating one or more sets of resources for a BWP of the UE; and determining at least one set of available resources for a subband based on the one or more sets of resources for the BWP.

Some other embodiments of the present disclosure also provide a method performed by a BS. The BS may include: a transceiver configured to transmit, to a UE, a configuration indicating one or more sets of resources for a BWP of the UE; and a processor coupled to the transceiver and configured to determine at least one set of available resources for a subband based on the one or more sets of resources for the BWP.

Some embodiments of the present disclosure provide an apparatus. According to some embodiments of the present disclosure, the apparatus may include: at least one non-transitory computer-readable medium having stored thereon computer-executable instructions; at least one receiving circuitry; at least one transmitting circuitry; and at least one processor coupled to the at least one non-transitory computer-readable medium, the at least one receiving circuitry and the at least one transmitting circuitry, wherein the at least one non-transitory computer-readable medium and the computer executable instructions may be configured to, with the at least one processor, cause the apparatus to perform a method according to some embodiments of the present disclosure.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure;

FIG. 2 illustrates exemplary duplex modes according to some embodiments of the present disclosure;

FIG. 3 illustrates exemplary types of advanced full duplex modes according to some embodiments of the present disclosure;

FIG. 4 illustrates exemplary radio resources in a time division duplex (TDD) system according to some embodiments of the present disclosure;

FIG. 5 is a flow chart illustrating an exemplary method for UL transmission in a full duplex system according to some embodiments of the present disclosure;

FIG. 6 illustrates an exemplary method for determining a PUCCH resource set and PUCCH resources according to some embodiments of the present disclosure;

FIGS. 7-11 illustrate exemplary PUSCH transmission methods according to some embodiments of the present disclosure;

FIG. 12 is a flow chart illustrating an exemplary method for UL transmission in a full duplex system according to some other embodiments of the present disclosure; and

FIG. 13 illustrates a simplified block diagram of an exemplary apparatus for UL transmission in a full duplex system according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

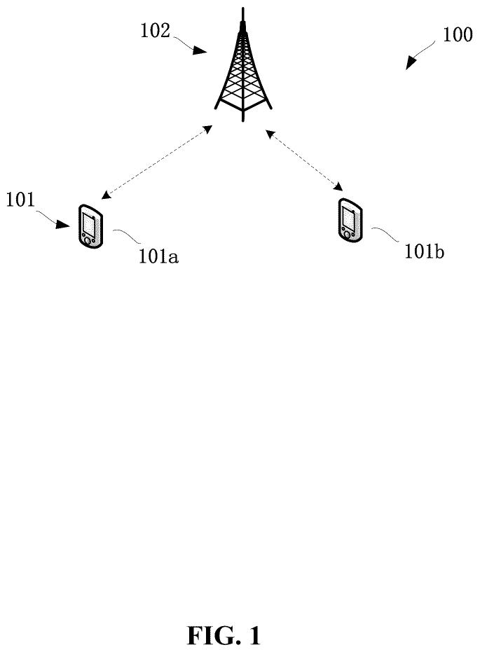

FIG. 1 illustrates a schematic diagram of a wireless communication system 100 in accordance with some embodiments of the present disclosure.

As shown in FIG. 1, wireless communication system 100 may include some UEs 101 (e.g., UE 101a and UE 101b) and a base station (e.g., BS 102). Although a specific number of UEs 101 and BS 102 is depicted in FIG. 1, it is contemplated that any number of UEs and BSs may be included in the wireless communication system 100.

The UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, the UE(s) 101 includes wearable devices, such as smart watches, fitness bands, optical head-mounted displays, or the like. Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. The UE(s) 101 may communicate with the BS 102 via uplink (UL) communication signals.

The BS 102 may be distributed over a geographic region. In certain embodiments of the present disclosure, the BS 102 may also be referred to as an access point, an access terminal, a base, a base unit, a macro cell, a Node-B, an evolved Node B (eNB), a gNB, a Home Node-B, a relay node, or a device, or described using other terminology used in the art. The BS 102 is generally a part of a radio access network that may include one or more controllers communicably coupled to one or more corresponding BSs 102. The BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and the UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, the BS 102 and UE(s) 101 may communicate using other communication protocols, such as the IEEE 802.11 family of wireless communication protocols. Further, in some embodiments of the present disclosure, the BS 102 and UE(s) 101 may communicate over licensed spectrums, whereas in some other embodiments, the BS 102 and UE(s) 101 may communicate over unlicensed spectrums. The present disclosure is not intended to be limited to the implementation of any particular wireless communication system architecture or protocol.

In a wireless communication system, the term “duplex” may mean bidirectional communications between two devices, in which “full duplex” means that a transmission over a link in each direction takes place at the same time and “half duplex” means that a transmission over a link in each direction takes place at mutual exclusive time.

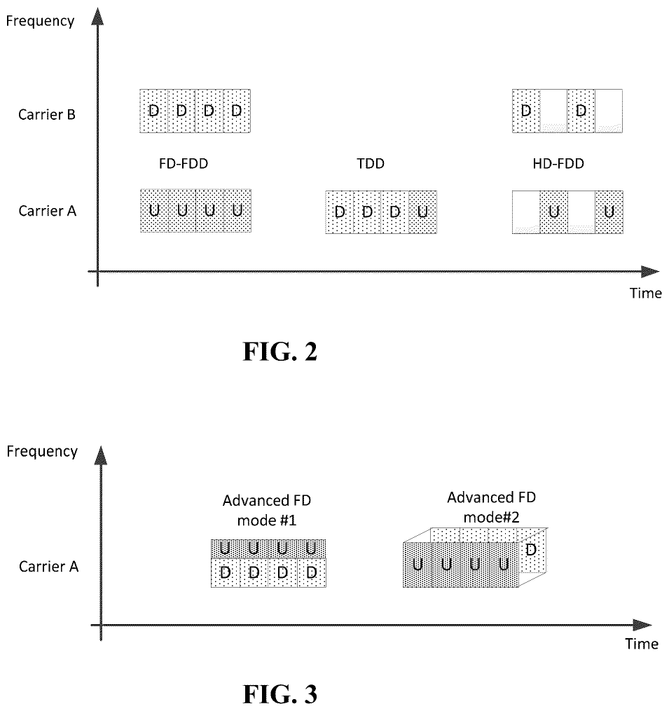

FIG. 2 illustrates exemplary duplex modes according to some embodiments of the present disclosure.

Referring to FIG. 2, duplex modes may include, for example, a full duplex frequency division duplex (FD-FDD) mode, a TDD mode, and a half duplex frequency division duplex (HD-FDD) mode.

In some examples, in a full duplex transceiver, different carrier frequencies (e.g., carrier A and carrier B) may be employed for transmissions in each link direction, for example, carrier A may be used for the uplink transmissions while carrier B may be used for the downlink transmissions. Such kind of full duplex may be referred to as the FD-FDD mode.

In a half duplex (HD) transceiver, transmissions in each link direction may be separated by time domain resources. In some cases, the same carrier frequency is used for transmissions in each link direction, for example, carrier A is used for both the uplink and downlink transmissions, such kind of half duplex may be referred to as the TDD mode. In some other cases, different carrier frequencies may be used for transmissions in each link direction, for example, carrier A may be used for the uplink transmissions while carrier B may be used for the downlink transmissions, such kind of half duplex may be referred to as the HD-FDD mode.

Embodiments of the present disclosure provide improvements on the FD-FDD mode illustrated in FIG. 2. For example, advanced full duplex modes which enable simultaneous transmission and reception by the same device on the same carrier are provided. The advanced full duplex modes are advantageous. For example, the advanced full duplex modes may improve the link throughput. In addition, the transmission latency in the advanced full duplex modes may also be reduced due to the bidirectional transmission simultaneously. Depending on whether the overlapped DL and UL resource occupation is allowed in the advanced full duplex modes, the advanced full duplex modes may be divided into several types.

FIG. 3 illustrates exemplary types of advanced full duplex modes according to some embodiments of the present disclosure.

Referring to FIG. 3, exemplary types of advanced full duplex modes may include advanced FD mode #1 and advanced FD mode #2. In advanced FD mode #1, the UL transmission and DL transmission occupy different frequency resources in the same carrier (e.g., carrier A), whereas in advanced FD mode #2, the UL transmission and DL transmission occupy overlapped resources in the same carrier (e.g., carrier A).

Simultaneous DL transmission and UL transmission in the same carrier may incur self-interference. For example, in the BS side, the DL transmission may contaminate UL reception, while in the UE side, the UL transmission may contaminate DL reception. Such self-interference level in advanced FD mode #1 would be much lower than that in advanced FD mode #2 because of the non-overlapped DL and UL resources.

It is more feasible to realize a full duplex in the BS side than in the UE side due to the following reasons. First, more space is available in the BS side such that transmitter (Tx) and receiver (Rx) antenna branches can be separated for self-interference cancellation. In addition, a more complex and advanced transceiver can be used in the BS side, which may be fundamental for self-interference cancellation.

Given the above, one scenario for implementing a full duplex mode is to deploy advanced FD mode #1 as shown in FIG. 3 in the BS side only, while still deploying a half duplex mode in the UE side. In such scenario, in a time unit (e.g., a slot) with a full duplex mode, the BS may perform UL receptions from some UEs while performing DL transmissions to some other UEs in non-overlapped frequency resources in the time unit.

The above scenario may be used in a TDD system to improve UL performance in the TDD system. For example, with the full duplex in the BS side, UL subband(s) may be configured in some DL slots such that the UL transmission can be extended to be within such subband(s) in the DL slots.

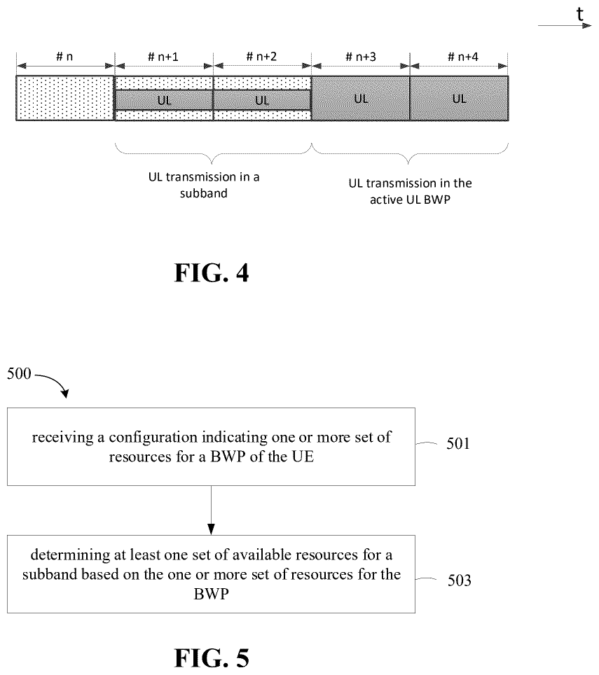

FIG. 4 illustrates exemplary radio resources in a TDD system according to some embodiments of the present disclosure.

In some examples, in a TDD system, DL transmissions and UL transmissions may be separated by time domain resources (e.g., slots). For example, the DL transmissions may be performed in DL slots #n-#n+2 as shown in FIG. 4 while the UL transmissions may be performed in the UL slots #n+3-#n+4 as shown in FIG. 4.

A full duplex mode in the BS side may be introduced to the TDD system. For example, for the UEs supporting the full duplex mode in the BS side, in addition to the UL transmission which may be scheduled in the active UL bandwidth parts (BWPs) in the UL slots, the UL transmission may also be scheduled in a subband in the DL slots in the TDD system. As shown in FIG. 4, UL transmissions may occur in a subband in DL slots #n+1 and #n+2. In other words, slot #n+1 and #n+2 are configured with UL subband(s).

The above embodiments illustrate can achieve better UL coverage, lower UL transmission latency and improved UL capability. In some embodiments of the present disclosure, the UL transmission (e.g., PUCCH transmission, PUSCH transmission, or any combination thereof) may be performed in a configured subband in one or more DL slots. Embodiments of the present disclosure provide solutions for determining the resources for PUCCH transmission and PUSCH transmission in a subband. For example, embodiments of the present disclosure propose solutions for UL transmission in a full duplex (FD) system (e.g., an advanced FD mode #1 is deployed in the BS side while a half duplex mode is deployed in the UE side), which can determine the resources for PUCCH transmission and/or PUSCH transmission in a subband.

In addition, solutions in the embodiments of the present disclosure also can reduce the signaling overhead for determining the resources for PUCCH transmission and/or PUSCH transmission in a subband and facilitate UL reception, thereby achieving better UL coverage, lower UL transmission latency and improved UL capability. More details on the embodiments of the present disclosure will be illustrated in the following text in combination with the appended drawings.

In order to reduce the signaling overhead for determining the resources for PUCCH transmission and/or PUSCH transmission in a subband and facilitate UL reception, embodiments of the present disclosure may reuse the PUCCH resources and/or PUSCH resources configured for the BWP for the PUCCH transmission and/or PUSCH transmission in a subband if certain conditions are met.

FIG. 5 illustrates methods for determining resources for PUCCH transmission and/or PUSCH transmission for a subband based on the PUCCH resources and/or PUSCH resources configured for a BWP.

Specifically, FIG. 5 is a flow chart illustrating an exemplary method 500 for UL transmission in a full duplex system according to some embodiments of the present disclosure. The method in FIG. 5 may be implemented by a UE (e.g., UE 101 as shown in FIG. 1).

In the exemplary method shown in FIG. 5, in step 501, a UE may receive a configuration indicating one or more sets of resources for a BWP of the UE from a BS (e.g., BS 102 as shown in FIG. 1). In step 503, the UE may determine at least one set of available resources for a subband based on the one or more sets of resources for the BWP.

In some embodiments of the present disclosure, the subband is associated with the BWP. In an embodiment of the present disclosure, a subband is associated with a BWP when a configuration for the subband (e.g., subband configuration) is within a configuration for the BWP (e.g., BWP configuration). In an embodiment of the present disclosure, a subband is associated with a BWP when the subband is separately configured (i.e., a configuration for the subband is separate from a configuration for the BWP), and the subband is within the region of the BWP. In an embodiment of the present disclosure, the UE may receive a configuration indicating that a subband is associated with a BWP from a BS.

According to some embodiments of the present disclosure, resources may be configured for transmitting a PUCCH in the BWP. For example, a PUCCH may be used for transmitting uplink control information (UCI), including for example hybrid automatic repeat request (HARQ)-acknowledgement (ACK) feedback, scheduling request (SR), and channel state information (CSI). In such embodiments, the one or more sets of resources may be one or more PUCCH resource sets for the BWP, wherein each PUCCH resource set may be configured with one or more PUCCH resources for the BWP.

In some embodiments, the configuration received by the UE in step 501 may include one or more first configurations, wherein each first configuration may indicate a corresponding PUCCH resource set. For example, a first configuration may be indicated by a parameter PUCCH-ResourceSet as specified in 3GPP specifications.

In an embodiment, each first configuration may indicate an ID of a corresponding PUCCH resource set, the PUCCH resource ID(s) included in the corresponding PUCCH resource set, and a maximum number of UCI information bits that the UE may transmit by using the PUCCH resource set. In some cases, a UE may be configured with up to 4 PUCCH resource sets for UCI feedback.

In some embodiments, the configuration received by the UE in step 501 may also include one or more second configurations indicating one or more PUCCH resources. The one or more PUCCH resources may be included in a PUCCH resource set. For example, a second configuration may be indicated by a parameter PUCCH-Resource as specified in 3GPP specifications.

In an embodiment, a second configuration may include at least one of the following parameters:
A resource ID (e.g., pucch-ResourceId as specified in 3GPP specifications) indicating an ID of a corresponding PUCCH resource;
An index (e.g., index #1) of the first PRB (e.g., startingPRB as specified in 3GPP specifications) in the first hop of the corresponding PUCCH resource when frequency hopping is configured or in the physical resources of the corresponding PUCCH resource when frequency hopping is not configured;
An index (e.g., index #2) of the first PRB (e.g., secondHopPRB as specified in 3GPP specifications) in the second hop of the corresponding PUCCH resource;
An intra-slot frequency hopping indication (e.g., intraSlotFrequencyHopping as specified in 3GPP specifications) which indicates whether an intra-slot frequency hopping is configured or not for the UE. For example, intraSlotFrequencyHopping being configured as “enabled” may mean that the intra-slot frequency hopping is configured for the UE; and intraSlotFrequencyHopping being configured as “disabled” may mean that the intra-slot frequency hopping is not configured for the UE.
When intra-slot frequency hopping is configured for the UE, the UE may transmit a PUCCH in physical resources (which starts from a PRB indicated by index #1) for the first hop and transmit the PUCCH in physical resources (which starts from a PRB indicated by index #2) for the second hop in the same slot.
A PUCCH format indication (e.g., format as specified in 3GPP specifications) which indicates a PUCCH format for the corresponding PUCCH resource.

In some embodiments, a PUCCH may be configured with a repetition number (denoted as N_rep), for example, N_rep may be 1, 2, 4, or 8. After receiving the configuration, the UE may repeat the PUCCH transmissions over N_rep time units (e.g., slots). A PUCCH transmission in each of the N_rep time units may have the same start symbol.

In some embodiments, in addition to the intra-slot frequency hopping indication, the UE may also receive an inter-slot frequency hopping indication (e.g., interslotFrequencyHopping as specified in 3GPP specifications) indicating whether an inter-slot frequency hopping is configured or not. For example, interslotFrequencyHopping being configured as “enabled” may mean that the inter-slot frequency hopping is configured for the UE; and interslotFrequencyHopping being configured as “disabled” may mean that the inter-slot frequency hopping is not configured for the UE. If inter-slot frequency hopping is configured for the UE, the UE may perform frequency hopping per time unit (e.g., per slot). For example, the UE may transmit the PUCCH in physical resources (which starts from a PRB indicated by index #1) for the first hop in even number time units among a plurality of time units and transmit the PUCCH in physical resources (which starts from a PRB indicated by index #1) for the second hop in odd number time units among the plurality of time units. In the above example, the number of the time units of the plurality of time units may refer to the above described N_rep for transmitting the PUCCH repetitions.

After receiving the configuration in step 501, in step 503, the UE may determine at least one available PUCCH resource set for the subband based on the one or more PUCCH resource sets for the BWP. The UE may determine at least one available PUCCH resource for the subband in the at least one available PUCCH resource set for the subband.

In some embodiments, the UE may determine a PUCCH resource set for the BWP to be an available PUCCH resource set for the subband in the case that at least one PUCCH resource in the PUCCH resource set is available for the subband.

The following embodiments provide several methods for determining whether a PUCCH resource is available for the subband.

In an embodiment of the present disclosure, frequency hopping (e.g., both intra-slot frequency hopping and inter-slot frequency hopping) may be not configured for the UE. In such embodiment, the UE may determine a PUCCH resource in a PUCCH resource set for the BWP to be an available PUCCH resource for the subband when a physical resource(s) of the PUCCH resource is within the subband. In such embodiment, the first PRB of the physical resource(s) herein may be indicated by index #1 included in a corresponding second configuration for the PUCCH resource as stated above. The size of the physical resource(s) (i.e., the number of PRBs included in the physical resource(s)) may be determined based on the PUCCH format for the PUCCH resource indicated by the second configuration.

In an embodiment of the present disclosure, frequency hopping (e.g., an intra-slot frequency hopping or an inter-slot frequency hopping) may be configured for the UE. In some examples, the UE may determine a PUCCH resource in a PUCCH resource set for the BWP to be an available PUCCH resource for the subband in the case that only a physical resource(s) for a first hop of the PUCCH resource is within the subband. In some examples, the UE may determine a PUCCH resource in a PUCCH resource set for the BWP to be an available PUCCH resource for the subband in the case that only a physical resource(s) for a second hop of the PUCCH resource is within the subband. In some examples, the UE may determine a PUCCH resource in a PUCCH resource set for the BWP to be an available PUCCH resource for the subband in the case that both a physical resource(s) for a first hop of the PUCCH resource and physical resource(s) for a second hop of the PUCCH resource are within the subband.

In such embodiment, the first PRB of the physical resource(s) for the first hop may be indicated by an index #1 included in a corresponding second configuration for the PUCCH resource as stated above. The first PRB of the physical resource(s) for the second hop may be indicated by an index #2 included in the second configuration for the PUCCH resource as stated above. The size of the physical resource(s) (i.e., the number of PRBs included in the physical resource(s)) for the first hop and the second hop may be determined based on the PUCCH format for the PUCCH resource indicated by the second configuration.

In an embodiment of the present disclosure, the subband may be configured with one or more PUCCH resources. For example, a configuration for the subband may include one or more resource IDs of the one or more PUCCH resources. In such embodiment, the UE may determine a PUCCH resource set for the BWP to be an available PUCCH resource set for the subband in the case that a resource ID of a PUCCH resource in the PUCCH resource set for the BWP is the same as a resource ID of a PUCCH resource configured for the subband. In such embodiments, although the PUCCH resource for the BWP and the PUCCH resource for the subband have the same ID, their configurations may be different. For example, they may have different starting PRBs, second hop PRBs, PUCCH formats, etc.

In such embodiment, for a PUCCH transmission in the subband, the UE may override the PUCCH resource configured for the BWP with the PUCCH resource configured for the subband.

Based on the above methods, the UE may determine PUCCH resource(s) available for the subband. In some embodiments of the present disclosure, an available PUCCH resource set for the subband determined by the UE may not include PUCCH resources with resource IDs not included in a PUCCH resource set for the BWP associated with the subband.

In some embodiments of the present disclosure, in the case that a PUCCH resource set does not include any PUCCH resource available for the subband (in other words, there is no PUCCH resource in the PUCCH resource set being available for the subband), the PUCCH resource set is not available for the subband. A PUCCH cannot be transmitted in the subband when using such PUCCH resource set to transmit the PUCCH.

In some embodiments of the present disclosure, if a PUCCH is indicated to be transmitted in a PUCCH resource, while the PUCCH resource is not available in the subband, then the PUCCH cannot be transmitted in the subband.

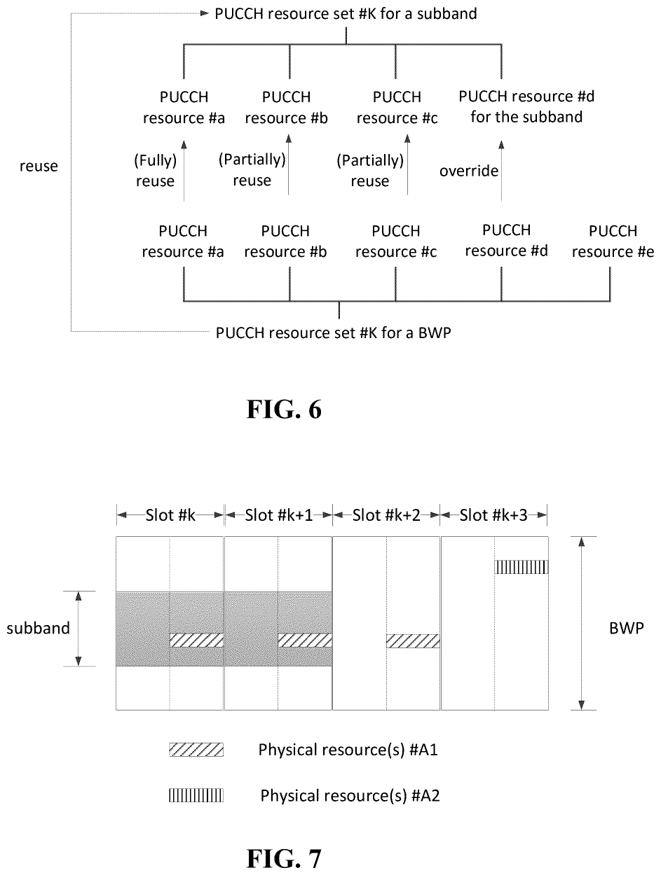

FIG. 6 illustrates an exemplary method for determining a PUCCH resource set and PUCCH resources according to some embodiments of the present disclosure.

Referring to FIG. 6, it is assumed that a UE is configured with PUCCH resource set #K for a BWP of the UE and PUCCH resource set #K includes five PUCCH resources whose resource IDs are #a, #b, #c, #d, and #e, respectively.

The UE may determine that PUCCH resource #a is available for the subband because physical resources of PUCCH resource #a are fully within the subband. For example, both the physical resources for the first hop and the physical resources for the second hop of PUCCH resource #a are fully within the subband.

The UE may determine that PUCCH resource #b is available for the subband because physical resources of PUCCH resource #b are partially within the subband. For example, only the physical resources for the first hop of PUCCH resource #b are within the subband but the physical resources for the second hop of PUCCH resource #b are not within the subband.

The UE may determine that PUCCH resource #c is available for the subband because physical resources of PUCCH resource #c are partially within the subband. For example, only the physical resources for the second hop of PUCCH resource #c are within the subband but the physical resources for the first hop of PUCCH resource #c are not within the subband.

The UE may determine that PUCCH resource #d is available for the subband because a PUCCH resource separately configured for the subband also indicates a resource ID of #d. The UE may override the PUCCH resource #d in PUCCH resource set #K for the BWP with PUCCH resource #d configured for the subband for a PUCCH transmission in the subband.

The UE may determine that PUCCH resource #e for the BWP is not available for the subband because the physical resources of PUCCH resource #e are not within the subband, and there is no separately configured PUCCH resource for the subband which has the same resource ID as PUCCH resource #e.

Since four PUCCH resources in PUCCH resource set #K for the BWP are available for the subband, the UE may determine PUCCH resource set #K for the BWP is an available PUCCH resource set for the subband, and the available PUCCH resources for the subband is PUCCH resource #a, PUCCH resource #b, and PUCCH resource #c in PUCCH resource set #K for the BWP and PUCCH resource #d configured for the subband.

After determining available PUCCH resource set(s) and available PUCCH resource(s) for the subband, when a PUCCH is indicated to be transmitted in a PUCCH resource available for the subband, the UE may transmit the PUCCH in the PUCCH resource based on solutions provided in the following embodiments.

In some embodiments, frequency hopping (e.g., both intra-slot frequency hopping and inter-slot frequency hopping) may be not configured for the UE. For a PUCCH resource which is determined to be an available PUCCH resource for the subband (e.g., a physical resource(s) of the PUCCH resource is within the subband), the UE may transmit a PUCCH in the physical resource(s) in the subband in one or more time units. In an embodiment of the present disclosure, a time unit may be a slot, a symbol, etc.

In some embodiments, a PUCCH may be determined to be an available PUCCH resource for the subband in the case that only physical resource(s) for a first hop of the PUCCH resource is within the subband. The UE may transmit a PUCCH in the physical resource(s) for the first hop in the subband in one or more time units without frequency hopping regardless of whether frequency hopping is configured for the UE. In an embodiment of the present disclosure, a time unit may be a slot, a symbol, etc.

For example, the UE may transmit a PUCCH in the physical resource(s) for the first hop in the subband in one or more time units without intra-slot frequency hopping even when intra-slot frequency hopping is configured for the UE. In another example, the UE may transmit a PUCCH in the physical resource(s) for the first hop in the subband in one or more time units without inter-slot frequency hopping even when inter-slot frequency hopping is configured for the UE.

If a PUCCH is indicated to be transmitted in a PUCCH resource in a time unit configured with a subband, the PUCCH could be transmitted in the physical resource(s) determined for the PUCCH resource in the subband.

If a PUCCH is indicated to be repeatedly transmitted in a PUCCH resource, then depending on the configured repetition number, the repetition could be happened in the time units that may include one or more time units configured with a subband, and may also include one or more time units configured with a BWP (i.e., UL time unit(s)). For the PUCCH transmission in the time unit(s) configured with a subband, the repetition can happen in the physical resource(s) determined for the PUCCH resource in the subband.

FIG. 7 illustrates an exemplary PUSCH transmission method according to some embodiments of the present disclosure.

Referring to FIG. 7, it is assumed that: a PUCCH is configured with N_rep=4 repetitions; the PUCCH is indicated to be transmitted in a PUCCH resource, wherein the PUCCH resource is configured with index #1 of the first PRB in a first hop and index #2 of the first PRB in a second hop; the PUCCH is indicated to be transmitted starting from slot #k; and the inter-slot frequency hopping is configured for the UE.

N_rep=4 repetitions means that the PUCCH may be transmitted in four consecutive slots repeatedly. In the example of FIG. 7, it is further assumed that slot #k and slot #k+1 are DL slots configured with a UL subband and slot #k+2 and slot #k+3 are UL slots.

After receiving the above PUCCH configurations, the UE may determine whether the PUCCH resource for the BWP is available for a subband associated with the BWP. In the example of FIG. 7, it is assumed that only physical resource(s) (physical resource(s) #A1) for the first hop of the PUCCH resource is within the subband and physical resource(s) (physical resource(s) #A2) for the second hop of the PUCCH resource is not within the subband.

Then, in slot #k and slot #k+1, the UE may transmit the PUCCH in physical resource(s) #A1 (i.e., starting from a PRB with index #1) in the subband without performing inter-slot frequency hopping. In the slot #k+2 and slot #k+3, the UE may transmit the PUCCH by inter-slot frequency hopping. For example, the UE may transmit the PUCCH in physical resource(s) #A1 in slot #k+2 and transmit the PUCCH in physical resource(s) #A2 in slot #k+3.

In some embodiments, a PUCCH may be determined to be an available PUCCH resource for the subband in the case that only physical resource(s) for a second hop of the PUCCH resource is within the subband. The UE may transmit a PUCCH in the physical resource(s) for the second hop in the subband in one or more time units without frequency hopping regardless of whether frequency hopping is configured for the UE. In an embodiment of the present disclosure, a time unit may be a slot, a symbol, etc.

For example, the UE may transmit a PUCCH in the physical resource(s) for the second hop in the subband in one or more time units without intra-slot frequency hopping even when intra-slot frequency hopping is configured for the UE. In another example, the UE may transmit a PUCCH in the physical resource(s) for the second hop in the subband in one or more time units without inter-slot frequency hopping even when inter-slot frequency hopping is configured for the UE.

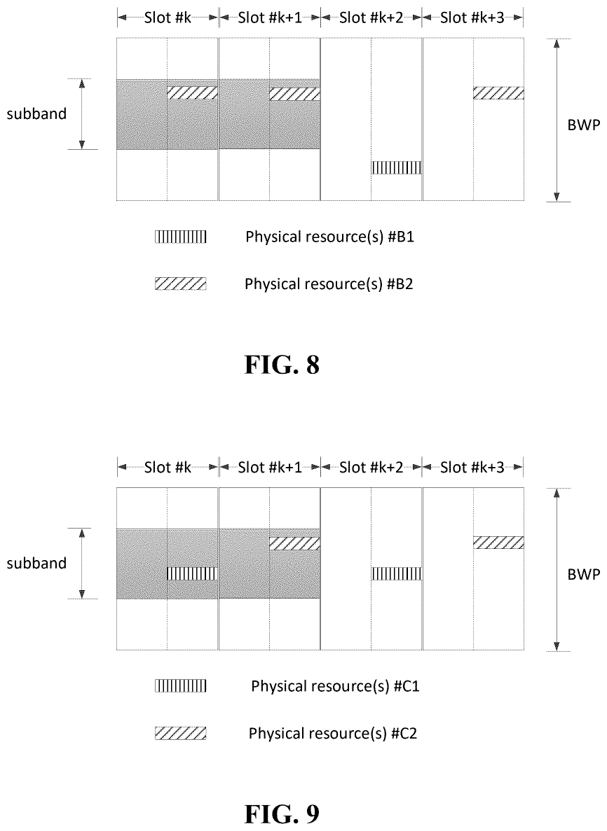

FIG. 8 illustrates an exemplary PUSCH transmission method according to some embodiments of the present disclosure.

Referring to FIG. 8, it is assumed that: a PUCCH is configured with N_rep=4 repetitions; the PUCCH is indicated to be transmitted in a PUCCH resource for the BWP, wherein the PUCCH resource is configured with index #1 of the first PRB in a first hop and index #2 of the first PRB in a second hop; the PUCCH is indicated to be transmitted starting from slot #k; and the inter-slot frequency hopping is configured for the UE.

N_rep=4 repetitions means that the PUCCH may be transmitted in four consecutive slots repeatedly. In the example of FIG. 8, it is further assumed that slot #k and slot #k+1 are DL slots configured with a UL subband and slot #k+2 and slot #k+3 are UL slots.

After receiving the above PUCCH configurations, the UE may determine whether the PUCCH resource for the BWP is available for a subband associated with the BWP. In the example of FIG. 8, it is assumed that only physical resource(s) (physical resource(s) #B2) for the second hop of the PUCCH resource is within the subband and physical resource(s) (physical resource(s) #B1) for the first hop of the PUCCH resource is not within the subband.

Then, in slot #k and slot #k+1, the UE may transmit the PUCCH in physical resource(s) #B2 (i.e., starting from a PRB with index #2) in the subband without performing inter-slot frequency hopping. In the slot #k+2 and slot #k+3, the UE may transmit the PUCCH by inter-slot frequency hopping. For example, the UE may transmit the PUCCH in physical resource(s) #B1 in slot #k+2 and transmit the PUCCH in physical resource(s) #B2 in slot #k+3.

In some embodiments, a PUCCH may be determined to be an available PUCCH resource for the subband in the case that both physical resource(s) for a first hop of the PUCCH resource and physical resource(s) for a second hop of the PUCCH resource are within the subband. The UE may transmit a PUCCH in the physical resource(s) for the first hop and the physical resource(s) for the second hop in the subband in one or more time units by frequency hopping when the frequency hopping is configured for the UE. In an embodiment of the present disclosure, a time unit may be a slot, a symbol, etc.

For example, when intra-slot frequency hopping is configured for the UE, the UE may transmit the PUCCH in physical resource(s) for the first hop and physical resource(s) for the second hop in the subband in the same time unit. When inter-slot frequency hopping is configured for the UE, the UE may transmit the PUCCH in physical resource(s) for the first hop in the subband in time units with even number among a set of consecutive time units and transmit the PUCCH in physical resource(s) for the second hop in the subband in time units with odd number among the set of consecutive time units. The number of time units in the set of consecutive time units may be N_rep configured for transmitting the PUCCH repetitions.

FIG. 9 illustrates an exemplary PUSCH transmission method according to some embodiments of the present disclosure.

Referring to FIG. 9, it is assumed that: a PUCCH is configured with N_rep=4 repetitions; the PUCCH is indicated to be transmitted in a PUCCH resource for the BWP, wherein the PUCCH resource is configured with index #1 of the first PRB in a first hop and index #2 of the first PRB in a second hop; the PUCCH is indicated to be transmitted starting from slot #k; and the inter-slot frequency hopping is configured for the UE.

N_rep=4 repetitions means that the PUCCH may be transmitted in four consecutive slots repeatedly. In the example of FIG. 9, it is further assumed that slot #k and slot #k+1 are DL slots configured with a subband and slot #k+2 and slot #k+3 are UL slots.

After receiving the above PUCCH configurations, the UE may determine whether the PUCCH resource for the BWP is available for a subband associated with the BWP. In the example of FIG. 9, it is assumed that physical resource(s) #C1 for the first hop and physical resource(s) #C2 for the second hop are both within the subband.

Then, in slot #k and slot #k+1, the UE may transmit the PUCCH in physical resource(s) #C1 and physical resource(s) #C2 in the subband by performing inter-slot frequency hopping. For example, the UE may transmit the PUCCH in physical resource(s) #C1 in slot #k and transmit the PUCCH in physical resource(s) #C2 in slot #k+1. In the slot #k+2 and slot #k+3, the UE may also transmit the PUCCH by inter-slot frequency hopping. For example, the UE may transmit the PUCCH in physical resource(s) #C1 in slot #k+2 and transmit the PUCCH in physical resource(s) #C2 in slot #k+3.

In some embodiments, a PUCCH resource set for a BWP may be determined to be an available PUCCH resource set for the subband in the case that a resource ID of a PUCCH resource in the PUCCH resource set is the same as the resource ID of a PUCCH resource (denoted as “another PUCCH resource” for clarity) configured for the subband.

Then, in the case that the another PUCCH resource comprises only a physical resource(s) for a first hop, the UE may transmit a PUCCH in the physical resource(s) for the first hop in the subband in one or more time units without frequency hopping regardless of whether frequency hopping is configured for the UE.

In the case that the another PUCCH resource comprises only a physical resource(s) for a second hop, the UE may transmit a PUCCH in the physical resource(s) for the second hop in the subband in one or more time units without frequency hopping regardless of whether frequency hopping is configured for the UE.

In the case that the another PUCCH resource comprises both the physical resource(s) for the first hop and the physical resource(s) for the second hop, the UE may transmit a PUCCH in the physical resource(s) for the first hop and second physical resource(s) for the second hop in the subband in one or more time units by frequency hopping when the frequency hopping is configured for the UE. For example, when intra-slot frequency hopping is configured for the UE, the UE may transmit the PUCCH in physical resource(s) for the first hop and physical resource(s) for the second hop in the subband in the same time unit. When inter-slot frequency hopping is configured for the UE, the UE may transmit the PUCCH in physical resource(s) for the first hop in the subband in time units with even number among a set of consecutive time units and transmit the PUCCH in physical resource(s) for the second hop in the subband in time units with odd number among the set of consecutive time units. The number of time units in the set of consecutive time units may be N_rep configured for transmitting the PUCCH repetitions. In an embodiment of the present disclosure, a time unit may be a slot, a symbol, etc.

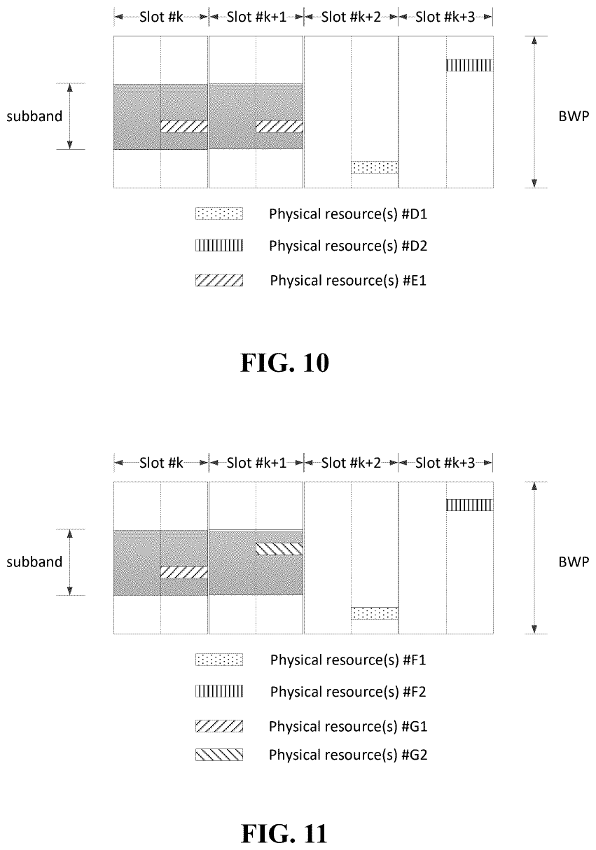

FIG. 10 illustrates an exemplary PUSCH transmission method according to some embodiments of the present disclosure.

Referring to FIG. 10, it is assumed that: a PUCCH is configured with N_rep=4 repetitions; the PUCCH is indicated to be transmitted in a PUCCH resource, wherein the PUCCH resource is configured with index #1 of the first PRB in a first hop and index #2 of the first PRB in a second hop; the PUCCH is indicated to be transmitted starting from slot #k; and the inter-slot frequency hopping is configured for the UE.

N_rep=4 repetitions means that the PUCCH may be transmitted in four consecutive slots repeatedly. In the example of FIG. 10, it is further assumed that slot #k and slot #k+1 are DL slots configured with a UL subband and slot #k+2 and slot #k+3 are UL slots.

After receiving the above PUCCH configurations, the UE may determine whether a PUCCH resource set including the PUCCH resource for the BWP is available for a subband associated with the BWP. In the example of FIG. 10, it is assumed that physical resource(s) #D1 for the first hop and physical resource(s) #D2 for the second hop of the PUCCH resource are both out of the subband. In some other examples, one or both of physical resource(s) #D1 physical resource(s) #D2 may be within the subband. A resource ID of the PUCCH resource for the BWP is the same as a resource ID of a PUCCH resource (denoted as “another PUCCH resource” for clarity) configured for the subband. The UE may determine the PUCCH resource set that includes the PUCCH resource for the BWP is available for the subband. It is assumed that: only an index (e.g., index #3) of the first PRB in a first hop is configured for the another PUCCH resource. That is, the another PUCCH resource only includes physical resource(s) #E1 for the first hop or for non-frequency hopping.

Then, in slot #k and slot #k+1, the UE may override the PUCCH resource for the BWP with the another PUCCH resource for the subband. For example, in slot #k and slot #k+1, the UE may transmit the PUCCH in physical resource(s) #E1 in the subband without performing inter-slot frequency hopping. In slot #k+2 and slot #k+3, the UE may transmit the PUCCH by inter-slot frequency hopping. For example, the UE may transmit the PUCCH in physical resource(s) #D1 in slot #k+2 and transmit the PUCCH in physical resource(s) #D2 in slot #k+3.

FIG. 11 illustrates an exemplary PUCCH transmission method according to some embodiments of the present disclosure.

Referring to FIG. 11, it is assumed that: a PUCCH is configured with N_rep=4 repetitions; the PUCCH is indicated to be transmitted in a PUCCH resource for the BWP, wherein the PUCCH resource is configured with index #1 of the first PRB in a first hop and index #2 of the first PRB in a second hop; the PUCCH is indicated to be transmitted starting from slot #k; and the inter-slot frequency hopping is configured for the UE.

N_rep=4 repetitions means that the PUCCH may be transmitted in four consecutive slots repeatedly. In the example of FIG. 11, it is further assumed that slot #k and slot #k+1 are DL slots configured with a UL subband and slot #k+2 and slot #k+3 are UL slots.

After receiving the above PUCCH configurations, the UE may determine whether a PUCCH resource set including the PUCCH resource for the BWP is available for a subband associated with the BWP. In the example of FIG. 11, it is assumed that physical resource(s) #F1 for the first hop and physical resource(s) #F2 for the second hop of the PUCCH resource are both out of the subband. In some other examples, one or both of physical resource(s) #F1 physical resource(s) #F2 may be within the subband. A resource ID of the PUCCH resource for the BWP is the same as a resource ID of a PUCCH resource (denoted as “another PUCCH resource” for clarity) configured for the subband. The UE may determine the PUCCH resource set that includes the PUCCH resource for the BWP is available for the subband. It is assumed that: an index (e.g., index #3) of the first PRB in a first hop and an index (e.g., index #4) of the first PRB in a second hop is configured for the another PUCCH resource. That is, the another PUCCH resource includes physical resource(s) #G1 for the first hop and physical resource(s) #G2 for the second hop.

Then, in slot #k and slot #k+1, the UE may override the PUCCH resource for the BWP with the another PUCCH resource for the subband. For example, in slot #k and slot #k+1, the UE may transmit the PUCCH in physical resource(s) #G1 and physical resource(s) #G2 in the subband by inter-slot frequency hopping. For example, the UE may transmit the PUCCH in physical resource(s) #G1 in slot #k and transmit the PUCCH in physical resource(s) #G2 in slot #k+1. In the slot #k+2 and slot #k+3, the UE may transmit the PUCCH in physical resource(s) #F1 and physical resource(s) #F2 by inter-slot frequency hopping. For example, the UE may transmit the PUCCH in physical resource(s) #F1 in slot #k+2 and transmit the PUCCH in physical resource(s) #F2 in slot #k+3.

The above embodiments provide solutions regarding how to determine available PUCCH resource set(s) and available PUCCH resource(s) for the subband. In some embodiments, the PUCCH resource set(s) may be used for transmitting a PUCCH carrying, for example, HARQ-ACK feedback.

Although the above embodiments are described with respect to a PUCCH resource set, it should be noted that a PUCCH resource set as described may include only a single PUCCH resource. Or there may be no such PUCCH resource set configuration, but just a PUCCH resource configured for PUCCH feedback. The above descriptions can also be applied to such case. For example, according to some embodiments of the present disclosure, the configuration received in step 501 may indicate a single PUCCH resource for PUCCH feedback. The PUCCH resource may be used to transmit a PUCCH carrying, for example, SR or CSI. For example, the configuration in step 501 may include only the second configuration as stated above, and the second configuration may indicate a single PUCCH resource. In such embodiments, determining at least one set of available resources for a subband based on the one or more sets of resources for the BWP in step 503 may mean that determining whether the single PUCCH resource for the BWP is an available PUCCH resource for the subband. All the above methods for determining whether a PUCCH resource for a BWP is an available PUCCH resource for a subband may apply herein. In addition, all the above methods for transmitting a PUCCH in a PUCCH resource available for the subband may also apply herein.

The above embodiments may provide solutions regarding how to determine available PUCCH resource(s) for the subband. Similar methods may be used for determining available PUSCH resource(s) for the subband.

For example, according to some embodiments of the present disclosure, the configuration received by the UE in step 501 may be for PUSCH resource allocation. For example, the configuration may be DCI indicating a set of PRBs for a PUSCH.

In some embodiments of the present disclosure, frequency hopping (e.g., both intra-slot frequency hopping and inter-slot frequency hopping) may be not configured for the UE. In such embodiment, the UE may determine the set of PRBs to be a set of available PUSCH resources for the subband in the case that the set of PRBs is within the subband. The UE may transmit a PUSCH in the set of PRBs in the subband in one or more time units. In an embodiment of the present disclosure, a time unit may be a slot, a symbol, etc.

In some embodiments, the UE may receive another configuration indicating a PRB offset value for the PUSCH. In such embodiments, in the case that frequency hopping is configured for the UE, the UE may determine a physical resource(s) for a first hop and a physical resource(s) for a second hop of the PUSCH based on a start PRB of the set of PRBs and the PRB offset value. In such embodiments, the one or more sets of resources determined based on the DCI may include two set of PUSCH resources, one set is physical resource(s) for a first hop and the other set is physical resource(s) for a second hop.

For example, the physical resource(s) for a first hop may be the set of PRBs indicated by the DCI as stated above. An index of the start PRB of the physical resource(s) for a second hop may be determined based on the start PRB of the set of PRBs indicated by the DCI and the PRB offset value, for example, according to the formula mod (startingPRB+RB_offset, N_BWP), wherein the parameter “startingPRB” is an index of the start PRB of the set of PRBs indicated by the DCI, the parameter RB_offset is the PRB offset value indicated by the another configuration, and the parameter N_BWP is the number of PRBs of the BWP. The number of PRBs included in the physical resource(s) for the second hop may be the same as the number of PRBs in the set of PRBs.

In an embodiment, the UE may determine the physical resource(s) for the first hop to be a set of available PUSCH resources for the subband in the case that only the physical resource(s) for the first hop is within the subband. The UE may transmit a PUSCH in the physical resource(s) for the first hop in the subband in one or more time units without frequency hopping regardless of whether frequency hopping is configured for the UE. In an embodiment of the present disclosure, a time unit may be a slot, a symbol, etc.

For example, the UE may transmit a PUSCH in the physical resource(s) for the first hop in the subband in one or more time units without intra-slot frequency hopping even when intra-slot frequency hopping is configured for the UE. In another example, the UE may transmit a PUSCH in the physical resource(s) for the first hop in the subband in one or more time units without inter-slot frequency hopping even when inter-slot frequency hopping is configured for the UE.

In an embodiment, the UE may determine the physical resource(s) for the second hop to be a set of available PUSCH resources for the subband in the case that only the physical resource(s) for the second hop is within the subband. The UE may transmit a PUSCH in the physical resource(s) for the second hop in the subband in one or more time units without frequency hopping regardless of whether frequency hopping is configured for the UE. In an embodiment of the present disclosure, a time unit may be a slot, a symbol, etc.

For example, the UE may transmit a PUSCH in the physical resource(s) for the second hop in the subband in one or more time units without intra-slot frequency hopping even when intra-slot frequency hopping is configured for the UE. In another example, the UE may transmit a PUSCH in the physical resource(s) for the second hop in the subband in one or more time units without inter-slot frequency hopping even when inter-slot frequency hopping is configured for the UE.

In an embodiment, the UE may determine the physical resource(s) for the first hop and the physical resource(s) for the second hop to be sets of available PUSCH resources for the subband in the case that both the physical resource(s) for the first hop and the physical resource(s) for the second hop are within the subband.

The UE may transmit a PUSCH in the physical resource(s) for the first hop and the physical resource(s) for the second hop in the subband in one or more time units by frequency hopping when the frequency hopping is configured for the UE. In an embodiment of the present disclosure, a time unit may be a slot, a symbol, etc.

For example, when intra-slot frequency hopping is configured for the UE, the UE may transmit the PUSCH in physical resource(s) for the first hop and physical resource(s) for the second hop in the subband in the same time unit. When inter-slot frequency hopping is configured for the UE, the UE may transmit the PUSCH in physical resource(s) for the first hop in the subband in time units with even number among a set of consecutive time units, and transmit the PUCCH in physical resource(s) for the second hop in the subband in time units with odd number among the set of consecutive time units. The number of time units in the set of consecutive time units may be equal to the number of repetitions configured for the PUSCH.

According to some embodiments of the present disclosure, the above solutions regarding determining the resource set(s) and resource(s) for PUCCH transmission in the subband can also be applied for determining resource set(s) and resource(s) for sounding reference signal (SRS) transmission in the subband.

It should be understood that although in the context of the present disclosure, terms such as “inter-slot” and “intra-slot” frequency hopping are used for simplicity, these terms may be replaced with “inter-time-unit” and “intra-time-unit” frequency hopping, without departing from the spirit and scope of the disclosure.

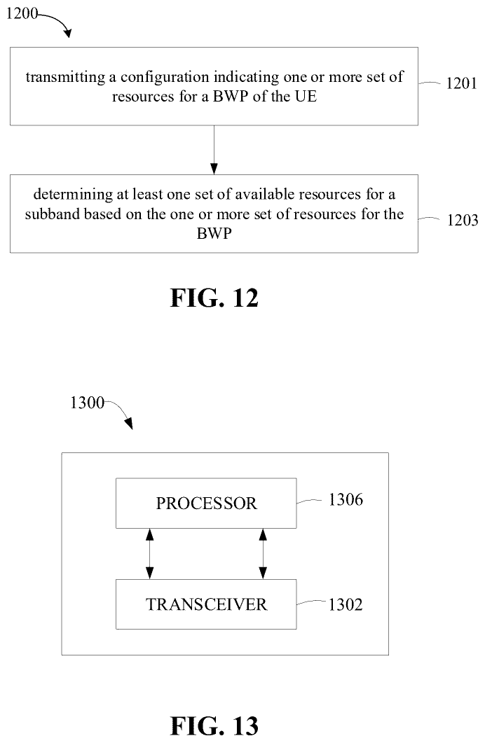

FIG. 12 is a flow chart illustrating an exemplary method 1200 for UL transmission in a full duplex system according to some embodiments of the present disclosure. The method in FIG. 12 may be implemented by a BS (e.g., BS 102 as shown in FIG. 1).

In the exemplary method shown in FIG. 12, in step 1201, the BS may transmit, to a UE (e.g., UE 101 as shown in FIG. 1), a configuration indicating one or more sets of resources for a BWP of the UE. In step 1203, the BS may determine at least one set of available resources for a subband based on the one or more sets of resources for the BWP.

In some embodiments of the present disclosure, the subband is associated with the BWP. In an embodiment of the present disclosure, a subband is associated with a BWP when a configuration for the subband (e.g., subband configuration) is within a configuration for the BWP (e.g., BWP configuration). In an embodiment of the present disclosure, a subband is associated with a BWP when the subband is separately configured (i.e., a configuration for the subband is separate from a configuration for the BWP), and the subband is within the region of the BWP. In an embodiment of the present disclosure, the BS may transmit a configuration indicating that a subband is associated with a BWP to a UE.

According to some embodiments of the present disclosure, resources may be configured for transmitting a PUCCH in the BWP. In such embodiments, the one or more sets of resources may be one or more PUCCH resource sets for the BWP, wherein each PUCCH resource set may be configured with one or more PUCCH resources for the BWP.

In some embodiments, the configuration transmitted by the BS in step 1201 may include one or more first configurations and one or more second configurations. The descriptions of first configuration and second configuration with respect to FIG. 5 may apply here and thus are omitted herein.

In step 1203, the BS may determine at least one available PUCCH resource set for the subband based on the one or more PUCCH resource sets for the BWP. The BS may determine at least one available PUCCH resource for the subband in the at least one available PUCCH resource set for the subband.

In some embodiments, the BS may determine a PUCCH resource set for the BWP to be an available PUCCH resource set for the subband in the case that at least one PUCCH resource in the PUCCH resource set is available for the subband.

The following embodiments provide several methods for determining whether a PUCCH resource is available for the subband.

In an embodiment of the present disclosure, frequency hopping (e.g., both intra-slot frequency hopping and inter-slot frequency hopping) may be not configured for the UE. In such embodiment, the BS may determine a PUCCH resource in a PUCCH resource set for the BWP to be an available PUCCH resource for the subband when a physical resource(s) of the PUCCH resource is within the subband. In such embodiment, the first PRB of the physical resource(s) herein may be indicated by index #1 included in a corresponding second configuration for the PUCCH resource as stated above. The size of the physical resource(s) (i.e., the number of PRBs included in the physical resource(s)) may be determined based on the PUCCH format for the PUCCH resource indicated by the second configuration.

In an embodiment of the present disclosure, frequency hopping (e.g., an intra-slot frequency hopping or an inter-slot frequency hopping) may be configured for the UE. In some examples, the BS may determine a PUCCH resource in a PUCCH resource set for the BWP to be an available PUCCH resource for the subband in the case that only a physical resource(s) for a first hop of the PUCCH resource is within the subband. In some examples, the BS may determine a PUCCH resource in a PUCCH resource set for the BWP to be an available PUCCH resource for the subband in the case that only a physical resource(s) for a second hop of the PUCCH resource is within the subband. In some examples, the BS may determine a PUCCH resource in a PUCCH resource set for the BWP to be an available PUCCH resource for the subband in the case that both a physical resource(s) for a first hop of the PUCCH resource and physical resource(s) for a second hop of the PUCCH resource are within the subband.

In such embodiment, the first PRB of the physical resource(s) for the first hop may be indicated by an index #1 included in a corresponding second configuration for the PUCCH resource as stated above. The first PRB of the physical resource(s) for the second hop may be indicated by an index #2 included in the second configuration for the PUCCH resource as stated above. The size of the physical resource(s) (i.e., the number of PRBs included in the physical resource(s)) for the first hop and the second hop may be determined based on the PUCCH format for the PUCCH resource indicated by the second configuration.

In an embodiment of the present disclosure, the BS may configure one or more PUCCH resources for the subband. For example, a configuration for the subband may include one or more resource IDs of the one or more PUCCH resources. In such embodiment, the BS may determine a PUCCH resource set for the BWP to be an available PUCCH resource set for the subband in the case that a resource ID of a PUCCH resource in the PUCCH resource set for the BWP is the same as a resource ID of a PUCCH resource configured for the subband. In such embodiments, although the PUCCH resource for the BWP and the PUCCH resource for the subband have the same ID, their configurations may be different. For example, they may have different starting PRBs, second hop PRBs, PUCCH formats, etc.

In such embodiment, for a PUCCH transmission in the subband, the BS may override the PUCCH resource configured for the BWP with the PUCCH resource configured for the subband.

Based on the above methods, the BS may determine PUCCH resource(s) available for the subband. In some embodiments of the present disclosure, an available PUCCH resource set for the subband determined by the BS may not include PUCCH resources with resource IDs not included in a PUCCH resource set for the BWP associated with the subband.

In some embodiments of the present disclosure, in the case that a PUCCH resource set does not include any PUCCH resource available for the subband (in other words, there is no PUCCH resource in the PUCCH resource set being available for the subband), the PUCCH resource set is not available for the subband. A PUCCH will not be received in the subband when using such PUCCH resource set to receive the PUCCH.

In some embodiments of the present disclosure, if a PUCCH is indicated to be transmitted in a PUCCH resource, while the PUCCH resource is not available in the subband, then the PUCCH will not be received in the subband.

After determining available PUCCH resource set(s) and available PUCCH resource(s) for the subband, when a PUCCH is indicated to be transmitted in a PUCCH resource available for the subband, the BS may receive the PUCCH in the PUCCH resource based on solutions provided in the following embodiments.

In some embodiments, frequency hopping (e.g., both intra-slot frequency hopping and inter-slot frequency hopping) may be not configured for the UE. For a PUCCH resource which is determined to be an available PUCCH resource for the subband (e.g., a physical resource(s) of the PUCCH resource is within the subband), the BS may receive a PUCCH in the physical resource(s) in the subband in one or more time units. In an embodiment of the present disclosure, a time unit may be a slot, a symbol, etc.

In some embodiments, a PUCCH may be determined to be an available PUCCH resource for the subband in the case that only physical resource(s) for a first hop of the PUCCH resource is within the subband. The BS may receive a PUCCH in the physical resource(s) for the first hop in the subband in one or more time units without frequency hopping regardless of whether frequency hopping is configured for the UE. In an embodiment of the present disclosure, a time unit may be a slot, a symbol, etc.

For example, the BS may receive a PUCCH in the physical resource(s) for the first hop in the subband in one or more time units without intra-slot frequency hopping even when intra-slot frequency hopping is configured for the UE. In another example, the BS may receive a PUCCH in the physical resource(s) for the first hop in the subband in one or more time units without inter-slot frequency hopping even when inter-slot frequency hopping is configured for the UE.

In some embodiments, a PUCCH may be determined to be an available PUCCH resource for the subband in the case that only physical resource(s) for a second hop of the PUCCH resource is within the subband. The BS may receive a PUCCH in the physical resource(s) for the second hop in the subband in one or more time units without frequency hopping regardless of whether frequency hopping is configured for the UE. In an embodiment of the present disclosure, a time unit may be a slot, a symbol, etc.

For example, the BS may receive a PUCCH in the physical resource(s) for the second hop in the subband in one or more time units without intra-slot frequency hopping even when intra-slot frequency hopping is configured to for UE. In another example, the BS may receive a PUCCH in the physical resource(s) for the second hop in the subband in one or more time units without inter-slot frequency hopping even when inter-slot frequency hopping is configured for the UE.

In some embodiments, a PUCCH may be determined to be an available PUCCH resource for the subband in the case that both physical resource(s) for a first hop of the PUCCH resource and physical resource(s) for a second hop of the PUCCH resource are within the subband. The BS may receive a PUCCH in the physical resource(s) for the first hop and the physical resource(s) for the second hop in the subband in one or more time units by frequency hopping when the frequency hopping is configured for the UE. In an embodiment of the present disclosure, a time unit may be a slot, a symbol, etc.

For example, when intra-slot frequency hopping is configured for the UE, the BS may receive the PUCCH in physical resource(s) for the first hop and physical resource(s) for the second hop in the subband in the same time unit. When inter-slot frequency hopping is configured for the UE, the BS may receive the PUCCH in physical resource(s) for the first hop in the subband in time units with even number among a set of consecutive time units and receive the PUCCH in physical resource(s) for the second hop in the subband in time units with odd number among the set of consecutive time units. The number of time units in the set of consecutive time units may be N_rep configured for transmitting the PUCCH repetitions.

In some embodiments, a PUCCH resource set for a BWP may be determined to be an available PUCCH resource set for the subband in the case that a resource ID of a PUCCH resource in the PUCCH resource set is the same as the resource ID of a PUCCH resource (denoted as “another PUCCH resource” for clarity) configured for the subband.

Then, in the case that the another PUCCH resource comprises only a physical resource(s) for a first hop, the BS may receive a PUCCH in the physical resource(s) for the first hop in the subband in one or more time units without frequency hopping regardless of whether frequency hopping is configured for the UE.

In the case that the another PUCCH resource comprises only a physical resource(s) for a second hop, the BS may receive a PUCCH in the physical resource(s) for the second hop in the subband in one or more time units without frequency hopping regardless of whether frequency hopping is configured for the UE.

In the case that the another PUCCH resource comprises both the physical resource(s) for the first hop and the physical resource(s) for the second hop, the UE may transmit a PUCCH in the physical resource(s) for the first hop and second physical resource(s) for the second hop in the subband in one or more time units by frequency hopping when the frequency hopping is configured for the UE. For example, when intra-slot frequency hopping is configured for the UE, the BS may receive the PUCCH in physical resource(s) for the first hop and physical resource(s) for the second hop in the subband in the same time unit. When inter-slot frequency hopping is configured for the UE, the BS may receive the PUCCH in physical resource(s) for the first hop in the subband in time units with even number among a set of consecutive time units and receive the PUCCH in physical resource(s) for the second hop in the subband in time units with odd number among the set of consecutive time units. The number of time units in the set of consecutive time units may be N_rep configured for transmitting the PUCCH repetitions. In an embodiment of the present disclosure, a time unit may be a slot, a symbol etc.

The above embodiments provide solutions regarding how to determine available PUCCH resource set(s) and available PUCCH resource(s) for the subband. In some embodiments, the PUCCH resource set(s) may be used for transmitting a PUCCH carrying, for example, HARQ-ACK feedback.

Although the above embodiments are described with respect to a PUCCH resource set, it should be noted that a PUCCH resource set as described may include only a single PUCCH resource. Or there may be no such PUCCH resource set configuration, but just a PUCCH resource configured for PUCCH feedback. The above descriptions can also be applied to such case. For example, according to some embodiments of the present disclosure, the configuration transmitted in step 1201 may indicate a single PUCCH resource for PUCCH feedback. The PUCCH resource may be used to transmit a PUCCH carrying, for example, SR or CSI. For example, the configuration in step 1201 may include only the second configuration as stated above, and the second configuration may indicate a single PUCCH resource. In such embodiments, determining at least one set of available resources for a subband based on the one or more sets of resources for the BWP in step 1203 may mean that determining whether the single PUCCH resource for the BWP is an available PUCCH resource for the subband. All the above methods for determining whether a PUCCH resource for a BWP is an available PUCCH resource for a subband may apply herein. In addition, all the above methods for receiving a PUCCH in a PUCCH resource available for the subband may also apply herein.

According to some embodiments of the present disclosure, the configuration transmitted by the BS in step 1201 may be for PUSCH resource allocation. For example, the configuration may be DCI indicating a set of PRBs for a PUSCH.

In some embodiments of the present disclosure, frequency hopping (e.g., both intra-slot frequency hopping and inter-slot frequency hopping) may be not configured for the UE. In such embodiment, the BS may determine the set of PRBs to be a set of available PUSCH resources for the subband in the case that the set of PRBs is within the subband.

The BS may receive a PUSCH in the set of PRBs in the subband in one or more time units. In an embodiment of the present disclosure, a time unit may be a slot, a symbol, etc.

In some embodiments, the BS may transmit another configuration indicating a PRB offset value for the PUSCH. In such embodiments, in the case that frequency hopping is configured for the UE, the BS may determine a physical resource(s) for a first hop and a physical resource(s) for a second hop of the PUSCH based on a start PRB of the set of PRBs and the PRB offset value. In such embodiments, the one or more sets of resources determined based on the DCI may include two set of PUSCH resources, one set is physical resource(s) for a first hop and the other set is physical resource(s) for a second hop.

For example, the physical resource(s) for a first hop may be the set of PRBs indicated by the DCI as stated above. An index of the start PRB of the physical resource(s) for a second hop may be determined based on the start PRB of the set of PRBs indicated by the DCI and the PRB offset value, for example, according to the formula mod (startingPRB+RB_offset, N_BWP), wherein the parameter “startingPRB” is an index of the start PRB of the set of PRBs indicated by the DCI, the parameter RB_offset is the PRB offset value indicated by the another configuration, and the parameter N_BWP is the number of PRBs of the BWP. The number of PRBs included in the physical resource(s) for the second hop may be the same as the number of PRBs in the set of PRBs.

In an embodiment, the BS may determine the physical resource(s) for the first hop to be a set of available PUSCH resources for the subband in the case that only the physical resource(s) for the first hop is within the subband. The BS may receive a PUSCH in the physical resource(s) for the first hop in the subband in one or more time units without frequency hopping regardless of whether frequency hopping is configured for the UE. In an embodiment of the present disclosure, a time unit may be a slot, a symbol, etc.

For example, the BS may receive a PUSCH in the physical resource(s) for the first hop in the subband in one or more time units without intra-slot frequency hopping even when intra-slot frequency hopping is configured for the UE. In another example, the BS may receive a PUSCH in the physical resource(s) for the first hop in the subband in one or more time units without inter-slot frequency hopping even when inter-slot frequency hopping is configured for the UE.

In an embodiment, the BS may determine the physical resource(s) for the second hop to be a set of available PUSCH resources for the subband in the case that only the physical resource(s) for the second hop is within the subband. The UE may transmit a PUSCH in the physical resource(s) for the second hop in the subband in one or more time units without frequency hopping regardless of whether frequency hopping is configured for the UE. In an embodiment of the present disclosure, a time unit may be a slot, a symbol, etc.

For example, the BS may receive a PUSCH in the physical resource(s) for the second hop in the subband in one or more time units without intra-slot frequency hopping even when intra-slot frequency hopping is configured for the UE. In another example, the BS may receive a PUSCH in the physical resource(s) for the second hop in the subband in one or more time units without inter-slot frequency hopping even when inter-slot frequency hopping is configured for the UE.

In an embodiment, the BS may determine the physical resource(s) for the first hop and the physical resource(s) for the second hop to be sets of available PUSCH resources for the subband in the case that both the physical resource(s) for the first hop and the physical resource(s) for the second hop are within the subband.

The BS may receive a PUSCH in the physical resource(s) for the first hop and the physical resource(s) for the second hop in the subband in one or more time units by frequency hopping when the frequency hopping is configured for the UE. In an embodiment of the present disclosure, a time unit may be a slot, a symbol, etc.

For example, when intra-slot frequency hopping is configured for the UE, the BS may receive the PUSCH in physical resource(s) for the first hop and physical resource(s) for the second hop in the subband in the same time unit. When inter-slot frequency hopping is configured for the UE, the BS may receive the PUSCH in physical resource(s) for the first hop in the subband in time units with even number among a set of consecutive time units, and receive the PUCCH in physical resource(s) for the second hop in the subband in time units with odd number among the set of consecutive time units. The number of time units in the set of consecutive time units may be equal to the number of repetitions configured for the PUSCH.

FIG. 13 illustrates a block diagram of an exemplary apparatus 1300 according to some embodiments of the present disclosure. As shown in FIG. 13, the apparatus 1300 may include at least one processor 1306 and at least one transceiver 1302 coupled to the processor 1306. The apparatus 1300 may be a UE or a BS.

Although in this figure, elements such as the at least one transceiver 1302 and processor 1306 are described in the singular, the plural is contemplated unless a limitation to the singular is explicitly stated. In some embodiments of the present disclosure, the transceiver 1302 may be divided into two devices, such as a receiving circuitry and a transmitting circuitry. In some embodiments of the present disclosure, the apparatus 1300 may further include an input device, a memory, and/or other components.

In some embodiments of the present disclosure, the apparatus 1300 may be a UE. The transceiver 1302 and the processor 1306 may interact with each other so as to perform the operations with respect to the UE described in FIGS. 1-12. In some embodiments of the present disclosure, the apparatus 1300 may be a BS. The transceiver 1302 and the processor 1306 may interact with each other so as to perform the operations with respect to the BS described in FIGS. 1-12.

In some embodiments of the present disclosure, the apparatus 1300 may further include at least one non-transitory computer-readable medium.

For example, in some embodiments of the present disclosure, the non-transitory computer-readable medium may have stored thereon computer-executable instructions to cause the processor 1306 to implement the method with respect to the UE as described above. For example, the computer-executable instructions, when executed, cause the processor 1306 interacting with transceiver 1302 to perform the operations with respect to the UE described in FIGS. 1-12.

In some embodiments of the present disclosure, the non-transitory computer-readable medium may have stored thereon computer-executable instructions to cause the processor 1306 to implement the method with respect to the BS as described above. For example, the computer-executable instructions, when executed, cause the processor 1306 interacting with transceiver 1302 to perform the operations with respect to the BS described in FIGS. 1-12.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE) for wireless communication, comprising:
at least one memory; and
at least one processor coupled with the at least one memory and configured to cause the UE to:
receive a configuration indicating one or more sets of resources for a bandwidth part (BWP) of the UE; and
determine at least one set of available resources for a subband based on the one or more sets of resources for the BWP.

2. The UE of claim 1, wherein the subband is associated with the BWP.

3. The UE of claim 1, wherein the one or more sets of resources are one or more physical uplink control channel (PUCCH) resource sets for the BWP, wherein each PUCCH resource set is configured with one or more PUCCH resources for the BWP;
wherein the at least one processor is further configured to cause the UE to:
determine, based on the one or more PUCCH resource sets for the BWP, at least one available PUCCH resource set for the subband; and
determine at least one available PUCCH resource for the subband in the at least one available PUCCH resource set for the subband.

4. The UE of claim 3, wherein, to determine at least one available PUCCH resource set for the subband, the at least one processor is configured to cause the UE to:
determine a PUCCH resource set for the BWP to be an available PUCCH resource set for the subband when at least one PUCCH resource in the PUCCH resource set is available for the subband.

5. The UE of claim 3, wherein the at least one processor is further configured to cause the UE to:
when frequency hopping is not configured for the UE, determine a PUCCH resource in a PUCCH resource set for the BWP to be an available PUCCH resource for the subband when a physical resource of the PUCCH resource is within the subband.

6. The UE of claim 3, wherein the at least one processor is further configured to cause the UE to:
determine a PUCCH resource in a PUCCH resource set for the BWP to be an available PUCCH resource for the subband in the case that:
only a first physical resource for a first hop of the PUCCH resource is within the subband,
only a second physical resource for a second hop of the PUCCH resource is within the subband, or
both the first physical resource for the first hop of the PUCCH resource and the second physical resource for the second hop of the PUCCH resource are within the subband.

7. The UE of claim 3, wherein, to determine at least one available PUCCH resource set for the subband, the at least one processor is configured to cause the UE to:
determine a PUCCH resource set for the BWP to be an available PUCCH resource set for the subband when a resource identity (ID) of a PUCCH resource in the PUCCH resource set for the BWP is the same as a resource ID of another PUCCH resource configured for the subband.

8. The UE of claim 7, wherein the at least one processor is further configured to cause the UE to override the PUCCH resource configured for the BWP with the another PUCCH resource configured for the subband for a PUCCH transmission in the subband.

9. The UE of claim 5, wherein the at least one processor is further configured to cause the UE to transmit a PUCCH in the physical resource in the subband in one or more time units.

10. The UE of claim 4, wherein the at least one processor is further configured to cause the UE to:
when only the first physical resource is within the subband, transmit a PUCCH in the first physical resource in the subband in one or more time units without frequency hopping regardless of whether frequency hopping is configured for the UE;
when only the second physical resource is within the subband, transmit a PUCCH in the second physical resource in the subband in one or more time units without frequency hopping regardless of whether frequency hopping is configured for the UE; or
when both the first physical resource and the second physical resource are within the subband, transmit a PUCCH in the first physical resource and the second physical resource in the subband in one or more time units by frequency hopping when the frequency hopping is configured for the UE.

11. The UE of claim 7, wherein the at least one processor is further configured to cause the UE to:
when the another PUCCH resource comprises only a first physical resource for a first hop, transmit a PUCCH in the first physical resource in the subband in one or more time units without frequency hopping regardless of whether frequency hopping is configured for the UE;
when the another PUCCH resource comprises only a second physical resource(s) for a second hop, transmit a PUCCH in the second physical resource in the subband in one or more time units without frequency hopping regardless of whether frequency hopping is configured for the UE; or
when the another PUCCH resource comprises both the first physical resource for the first hop and the second physical resource for the second hop, transmit a PUCCH in the first physical resource and second physical resource in the subband in one or more time units by frequency hopping when the frequency hopping is configured for the UE.

12. The UE of claim 1, wherein the configuration is for physical uplink shared channel (PUSCH) resource allocation and is downlink control information (DCI) indicating a set of physical resource blocks (PRBs) for a PUSCH.

13. The UE of claim 12, wherein the at least one processor is configured to cause the UE to determine the at least one set of available resources for the subband by determining the set of PRBs to be a set of available PUSCH resources for the subband when the set of PRBs is within the subband.

14. A base station (BS), comprising:
at least one memory; and
at least one processor coupled with the at least one memory and configured to cause the UE to:
transmit, to a user equipment (UE), a configuration indicating one or more sets of resources for a bandwidth part (BWP) of the UE; and
at least one set of available resources for a subband based on the one or more sets of resources for the BWP.

15. A method performed by a user equipment (UE), the method comprising:
receiving a configuration indicating one or more sets of resources for a bandwidth part (BWP) of the UE; and
determining at least one set of available resources for a subband based on the one or more sets of resources for the BWP.

16. The UE of claim 7, wherein a PUCCH resource configured for the subband has a different configuration with respect to a PUCCH resource configured for the BWP with a same resource ID, wherein the different configuration includes starting physical resource blocks (PRB), a second hop PRB, or a PUCCH format of the PUCCH resource configured for the subband.

17. A processor for wireless communication, comprising:
at least one controller coupled with the at least one memory and configured to cause the processor to:
receive a configuration indicating one or more sets of resources for a bandwidth part (BWP) of the processor; and
determine at least one set of available resources for a subband based on the one or more sets of resources for the BWP.

18. The processor of claim 17, wherein the one or more sets of resources are one or more physical uplink control channel (PUCCH) resource sets for the BWP, wherein each PUCCH resource set is configured with one or more PUCCH resources for the BWP;
wherein the at least one controller is further configured to cause the processor to:
determine, based on the one or more PUCCH resource sets for the BWP, at least one available PUCCH resource set for the subband; and
determine at least one available PUCCH resource for the subband in the at least one available PUCCH resource set for the subband.

19. The processor of claim 17, wherein the configuration is for physical uplink shared channel (PUSCH) resource allocation and is downlink control information (DCI) indicating a set of physical resource blocks (PRBs) for a PUSCH.

20. The processor of claim 17, wherein the at least one controller is configured to cause the processor to determine the at least one set of available resources for the subband by determining the set of PRBs to be a set of available PUSCH resources for the subband when the set of PRBs is within the subband.
